(19) United States
(12) Patent Application Publication
(10) Pub. No.: US 2005/0064861 A1
(43) Pub. Date: Mar. 24, 2005

(54) Information communication method, system, and apparatus

(75) Inventor: Junichi Nishida, Aichi-ken (JP)

Correspondence Address: Finnegan, Henderson, Farabow,;Garrett & Dunner, L.L.P., 1300 I Street, N.W., Washington, DC, 20005-3315, US

(73) Assignee: Toyota Jidosha Kabushiki Kaisha

(21) Appl. No.: 10/944,876

(22) Filed: Sep. 21, 2004

(30) Foreign Application Priority Data
Sep. 22, 2003 (JP) 2003-329732

(51) Int. Cl. H04M 11/00

(52) U.S. Cl. 455/420; 455/418

(57) ABSTRACT

A user makes a contract concerning provision of a rescue service with a center in advance. The center sends service contract expiration date information to an in-vehicle information terminal device. A microcomputer of the in-vehicle information terminal device receives and stores the service contract expiration date information that is sent. Then, the microcomputer determines whether an expiration date of the service contract has been passed, every time an ignition switch is turned on. If the expiration date has been passed, the microcomputer sends contract renewal determination information and vehicle ID information to the center. The center determines whether the contract has been renewed based on the vehicle ID information. If the contract has been renewed, the center sends the latest service contract expiration date information to the in-vehicle information terminal device.

### INCORPORATION BY REFERENCE

The disclosure of Japanese Patent Application No. 2003-329732 filed on Sep. 22, 2003 including the specification, drawings and abstract is incorporated herein by reference in its entirety.

### BACKGROUND OF THE INVENTION

1. Field of the Invention

The invention relates to an information communication method, an information communication system, and an information communication apparatus, in which communication is performed based on a contract concerning communication.

2. Description of the Related Art

A member management method for managing information concerning members is known. An example of such a member management method is disclosed in Japanese Patent Laid-Open Publication No. 11-250383. In the member management method, a user makes a contract concerning provision of services with a center which provides various services in advance, and the center provides various services to the user via a wireless channel during a contract period. Also, the center notifies an in-vehicle device that the contract period will expire soon immediately before the contract period expires, and the user can apply for renewal of contract using the in-vehicle device.

However, in the aforementioned member management method, when the center notifies the in-vehicle device that the contract period will expire soon, there is a possibility that a communication channel cannot be established due to the reason that the vehicle is parked in a garage and the state of communication is deteriorated, or other reason. In this case, it is difficult for the center to unilaterally cancel the contract if the provided service is especially important. Therefore, it may be necessary to continue to provide the service to the user free of charge for a predetermined period.

Also, a chargeable service providing system is known. An example of the chargeable service providing system is disclosed in Japanese Patent Laid-Open Publication No. 2002-279316. In the chargeable service providing system, if a user has made a contract concerning provision of a service with a center which provides the service in advance, the center provides the service to the user via a wireless channel at a regular fee. If a user has not made the contract with the center, or if a contract period has expired, the center provides the service to the user via a wireless channel at a fee higher than the regular fee. In this case, the user can newly make a contract with the center.

However, in the chargeable service providing system, the user cannot easily determine if the service contract period has expired. Therefore, particularly when the user is not an owner of a vehicle, there is a possibility that the user cannot receive the service though the user wants to receive the service.

### SUMMARY OF THE INVENTION

It is an object of the invention to provide an information communication method and an information communication apparatus in which a state of a contract concerning communication is determined so as to perform communication.

A first aspect of the invention relates to an information communication method in which a first device and a second device communicate with each other based on a communication contract. The information communication method includes the steps of: in the first device: storing information concerning the communication contract which has been made in advance in such a manner that the information can be renewed; and sending the stored information concerning the communication contract to the second device; in the second device: receiving and storing the information concerning the communication contract sent by the first device; and sending, to the first device, contract renewal determination information used for determining whether the communication contract has been renewed; and in the first device: sending information concerning the renewed communication contract to the second device if the communication contract has been renewed.

In the first aspect of the invention, the second device may receive and store contract expiration date information indicating an expiration date of the communication contract, which is sent by the first device; the second device may determine if the expiration date of the communication contract has been passed; the second device may send, to the first device, contract renewal determination information used for determining whether the communication contract has been renewed if the expiration date of the communication contract has been passed; the first device may receive the contract renewal determination information sent by the second device; and the first device may send, to the second device, the contract expiration date information in the information concerning the renewed communication contract if the communication contract has been renewed.

In the first aspect of the invention, one of the first device and the second device may be installed in a center which provides various services to a user, and the other of the first device and the second device may be installed in a vehicle used by the user. Also, the contract renewal determination information may be sent within a predetermined time after operation of the second device is started. Also, the contract renewal determination information may be sent within a predetermined time after an engine of the vehicle is started when the second device is installed in the vehicle. Further, the information concerning the communication contract may be included in information concerning a contract for provision of the various services.

According to the information communication method, the first device and the second device can maintain the same information concerning the communication contract (for example, communication destination information and communication contract period information). Also, for example, even when the contract period has been renewed and extended, since the information concerning the communication contract in the first device and that in the second device are synchronized, the first device and the second device can maintain the same information concerning the communication contract. Thus, the first device and the second device can communicate with each other based on the correct communication contract.

Also, the second device sends the contract renewal determination information, and the first device receives the contract renewal determination information, whereby the information concerning the communication contract in the first device and that in the second device are synchronized. Accordingly, for example, it is possible to minimize the possibility that the communication channel cannot be established due to a deteriorated state of communication. Therefore, the information concerning the communication contract in the first device and that in the second device can be synchronized with more reliability, and the center can reduce a period during which the service is provided free of charge after the contract period expires. Also, since the second device maintains the contract expiration date information, and sends the contract renewal determination information when the contract period has expired, the number of times of communication can be reduced, which is advantageous.

In the case where the first device and the second device are installed in the center which provides the services and the vehicle which receives the services, respectively, since the first device and the second device communicates with each other based on the synchronized communication contract, the services can be reliably provided, and the services can be reliably received. Also, since the communication contract is included in the information concerning the contract for provision of the services, the user who receives the services can determine whether a contract period of the contract for provision of the services has expired. Accordingly, it is possible to prevent the communication contract from being cancelled though the user wants to receive the services. Also, even the user who is not the owner of the vehicle can determine the state of the contract extremely easily. Further, since the contract renewal determination information is sent within the predetermined time after the operation of the second device is started or the engine of the vehicle is started, the number of times of communication can be reduced, and a load of the communication channel can be reduced.

A second aspect of the invention relates to an information communication system in which a first device and a second device communicate with each other on a communication contract. In the information communication system, the first device includes a first storage device which stores information concerning the communication contract which has been made in advance in such a manner that the information can be renewed; an information renewal device which renews the information concerning the communication contract stored by the storage device; a first sending device which sends, to the second device, the information concerning the communication contract stored by the storage device; and a first receiving device which receives, from the second device, contract renewal determination information used for determining whether the communication contract has been renewed; and the second device includes a second receiving device which receives the information concerning the communication contract sent by the first device; a second storage device which stores the information concerning the communication contract received by the receiving device; and a second sending device which sends the contract renewal determination information to the first device.

In the second aspect of the invention, the first device may further include an information retrieving device which retrieves contract expiration date information indicating an expiration date of the communication contract in the information concerning the communication contract stored by the first storage device; and a contract information renewal determination device which determines whether the information concerning the communication contract has been renewed based on the contract renewal determination information received by the first receiving device; and the second device may further include a contract expiration date determination device which determines whether the expiration date of the communication contract has been passed based on the contract expiration date information stored by the second storage device. In the information communication system, the first sending device may send, to the second device, the contract expiration date information retrieved by the information retrieving device; and the second sending device may send the contract renewal determination information to the first device when the contract expiration date determination device determines that the expiration date of the communication contract has been passed.

In the second aspect of the invention, one of the first device and the second device may be installed in a center which provides various services to a user, and the other of the first device and the second device may be installed in a vehicle used by the user.

In the second aspect of the invention, the contract renewal determination information may be sent within a predetermined time after operation of the second device is started.

In the second aspect of the invention, the contract renewal determination information may be sent within a predetermined time after an engine of the vehicle is started when the second device is installed in the vehicle.

In the second aspect of the invention, the information concerning the communication contract may be included in information concerning a contract for provision of the various services.

A third aspect of the invention relates to an information communication apparatus which communicates with an external element based on a communication contract. The information communication apparatus includes storage device which stores information concerning the communication contract that has been made in advance in such a manner that the information can be renewed; an information renewal device which renews the information concerning the communication contract stored by the storage device; a sending device which sends, to the external element, the information concerning the communication contract stored by the storage device; and a receiving device which receives, from the external element, contract renewal determination information used for determining whether the communication contract has been renewed.

In the third aspect of the invention, the information communication apparatus may further include an information retrieving device which retrieves contract expiration date information indicating an expiration date of the communication contract in the information concerning the communication contract stored by the storage device; and a contract information renewal determination device which determines whether the information concerning the communication contract has been renewed based on the contract renewal determination information received by the receiving device.

In the third aspect of the invention, the information communication apparatus may be installed in a center which provides various services to the external element or a vehicle.

In the third aspect of the invention, the contract renewal determination information may be sent within a predetermined time after operation of the information communication apparatus is started.

In the third aspect of the invention, the contract renewal determination information may be sent within a predetermined time after an engine of the vehicle is started when the information communication apparatus is installed in the vehicle.

In the third aspect of the invention, the information concerning the communication contract may be included in information concerning a contract for provision of the various services.

A fourth aspect of the invention relates to an information communication apparatus which communicates with an external element based on a communication contract. The information communication apparatus includes a receiving device which receives, from the external element, information concerning the communication contract; a storage device which stores information concerning the communication contract received by the receiving device; and a sending device which sends, to the external element, contract renewal determination information used for determining whether the communication contract has been renewed.

In the fourth aspect of the invention, the information communication apparatus may further include a contract expiration date determination device which determines whether an expiration date of the communication contract has been passed based on contract expiration date information indicating the expiration date of the communication contract, which is stored by the storage device. The sending device may send, to the external element, the contract renewal determination information used for determining whether the communication contract has been renewed when it is determined, by the contract expiration date determination device, that the expiration date of the communication contract has been passed.

In the fourth aspect of the invention, the information communication apparatus may be installed in a center which provides various services to the external element or a vehicle.

In the fourth aspect of the invention, the contract renewal determination information may be sent within a predetermined time after operation of the information communication apparatus is started.

In the fourth aspect of the invention, the contract renewal determination information may be sent within a predetermined time after an engine of the vehicle is started when the information communication apparatus is installed in the vehicle.

In the fourth aspect of the invention, the information concerning the communication contract may be included in information concerning a contract for provision of the various services.

### BRIEF DESCRIPTION OF THE DRAWINGS

The foregoing and further objects, features and advantages of the invention will become apparent from the following description of exemplary embodiments with reference to the accompanying drawings, wherein like numerals are used to represent like elements and wherein:

FIG. 1 is a schematic block diagram showing an entire configuration of a communication system according to an embodiment of the invention;

FIG. 2 is a schematic block diagram showing an outline of an in-vehicle information terminal device shown in FIG. 1;

FIG. 3 is a schematic block diagram showing an outline of a center shown in FIG. 1;

FIG. 4 is a flow chart of a rescue service contract program performed in the in-vehicle information terminal device and the center shown in FIG. 1; and

FIG. 5 is a flow chart of a service contract state determination program performed in the in-vehicle information terminal device and the center shown in FIG. 1.

### DETAILED DESCRIPTION OF THE PREFERRED EMBODIMENTS

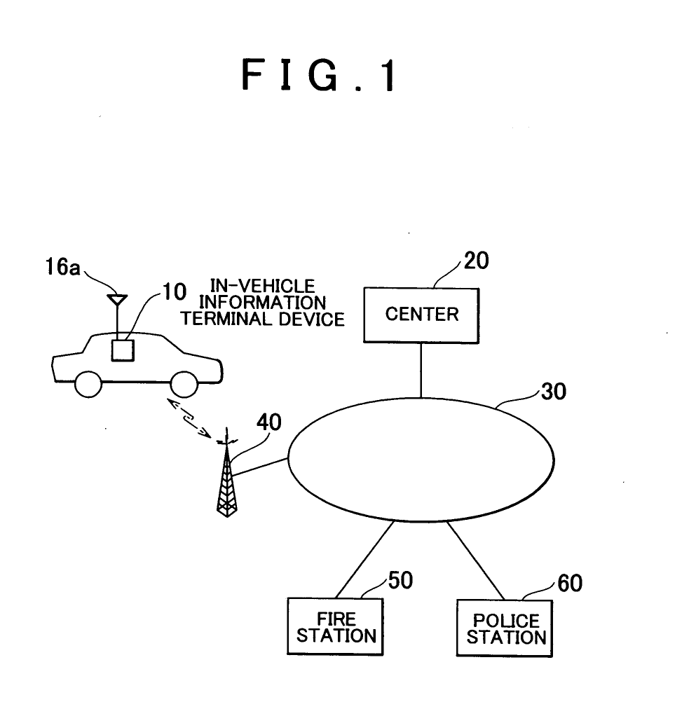

Hereinafter, an embodiment of the invention will be described with reference to the accompanying drawings. FIG. 1 is a block diagram which schematically shows an information communication system in which a center provides a service to a user of a vehicle according to the embodiment of the invention. In the embodiment, the service provided by the center is a rescue service in which the center requests an emergency vehicle or the like to go into action based on emergency information sent from the vehicle.

The communication system includes an in-vehicle information terminal device 10 which is installed in the vehicle, and which functions as the second device; and a center 20 which can perform wireless communication with the in-vehicle information terminal device 10, and which functions as the first device. The center 20 is connected, via a network 30 (for example, a public line such as a telephone line) to a base station 40 which performs wireless communication with the in-vehicle information terminal device 10, and a fire station 50 and a police station 60 for providing the rescue service.

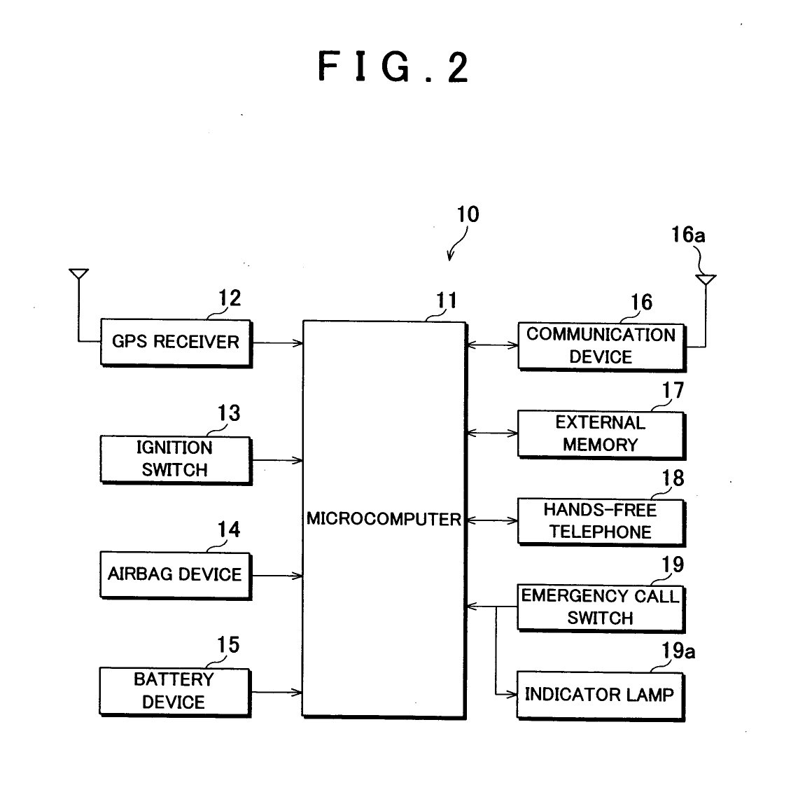

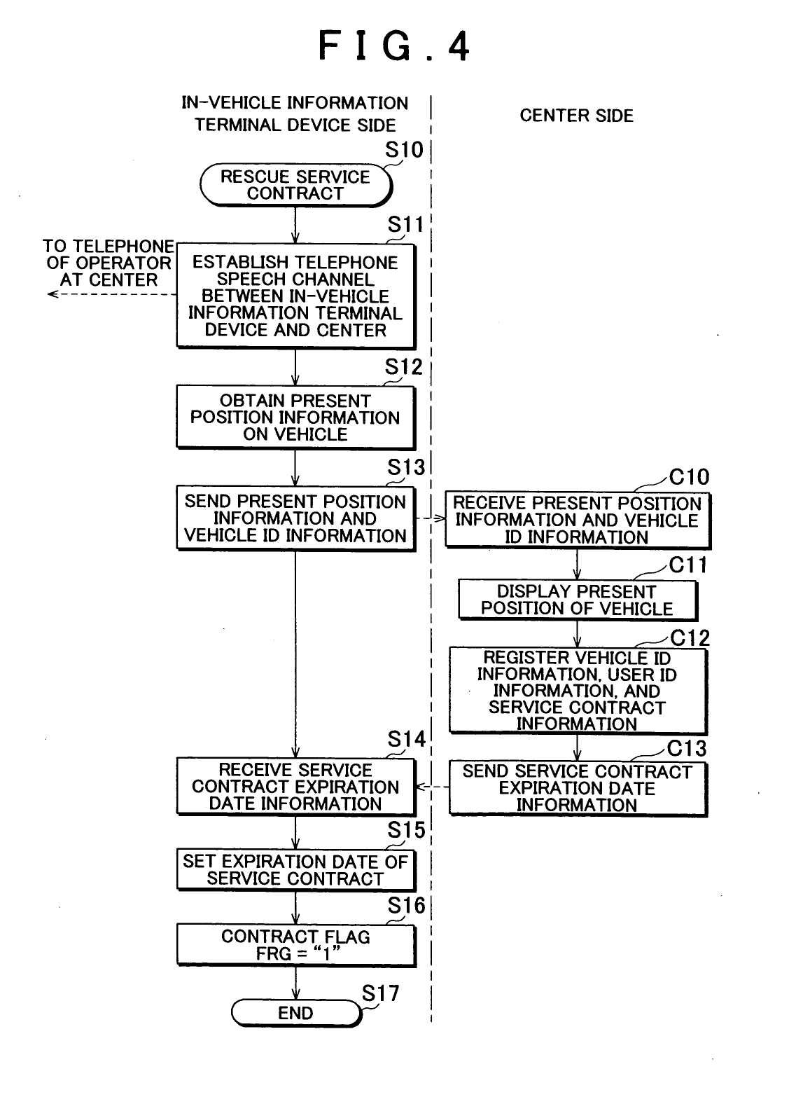

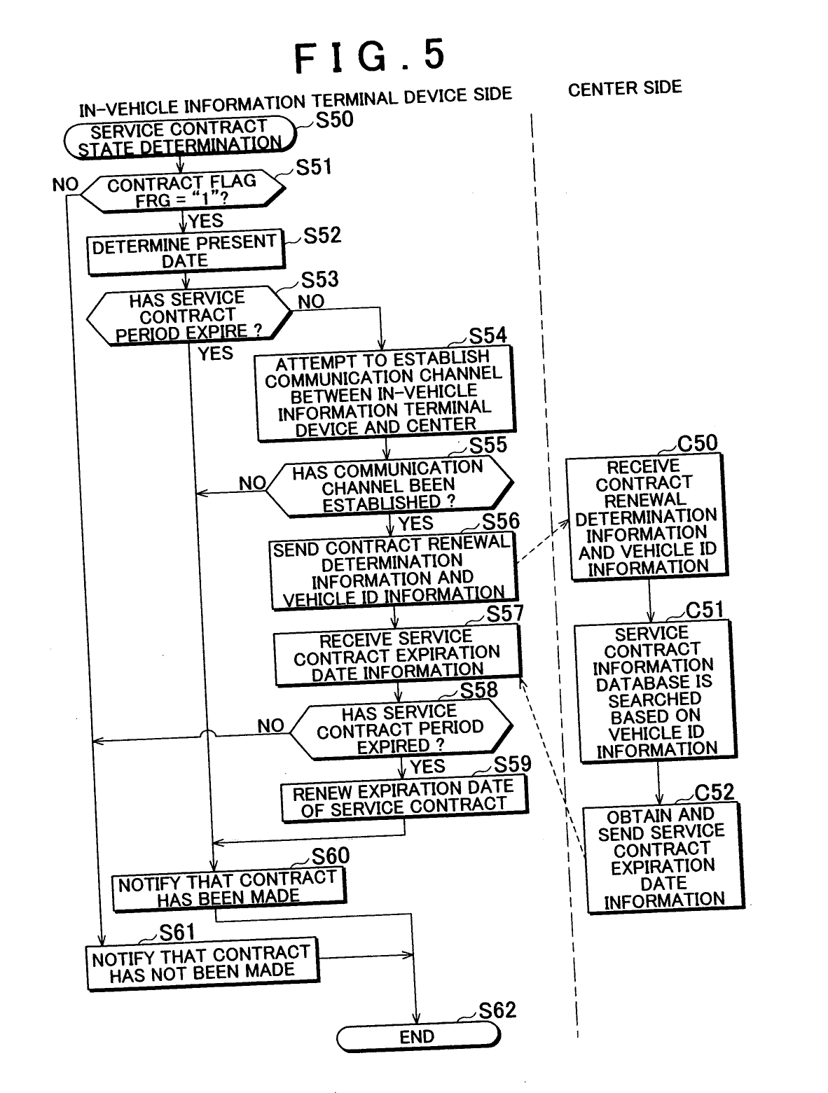

As shown in FIG. 2, the in-vehicle information terminal device 10 includes a microcomputer 11. The microcomputer 11 is connected to a GPS (Global Positioning System) receiver 12, an ignition switch 13, an airbag device 14, and a battery device 15. The microcomputer 11 mainly includes a CPU, ROM, RAM and a timer. The microcomputer 11 controls operation of the in-vehicle information terminal device 10 by performing various programs including programs on the in-vehicle information terminal device side shown in FIG. 4 and FIG. 5. The microcomputer 11 performs a communication channel establishment process, a service contract period determination process, and the like, which will be described later.

The GPS receiver 12 detects and outputs a present position of the vehicle as coordinate data. In the case where a navigation system is installed in the vehicle, coordinate data detected by a GPS receiver provided in the navigation system may be output. The ignition switch 13 is operated by the user of the vehicle. When the ignition switch 13 is turned on, an engine of the vehicle is started. When the ignition switch 13 is turned off, the engine is stopped. The ignition switch 13 outputs information indicating an operating state of the engine according to the on/off state thereof.

The airbag device 14 protects an occupant when a vehicle collision occurs. When the vehicle collision occurs, an airbag (not shown) is inflated, and protects the occupant from a shock due to the collision. After the airbag is inflated, the airbag device 14 outputs an emergency signal indicating emergency to the microcomputer 11. The battery device 15 supplies electric power necessary for operating various devices installed in the vehicle.

The microcomputer 11 is connected to a communication device 16, an external memory 17, and a hands-free telephone 18. The communication device 16 can perform wireless communication with the base station 40. The communication device 16 is connected to an antenna 16a for wireless communication. As the communication device 16, it is possible to use a cellular phone of the user, which is connected via a cradle. The external memory 17 includes a hard disk, a nonvolatile, writable memory such as nonvolatile RAM. The external memory 17 stores the aforementioned programs performed by the microcomputer 11, vehicle ID information used for identifying the vehicle which is given to the vehicle in advance when manufactured, telephone numbers including the telephone number of the center 20, and the like.

The hands-free telephone 18 includes a microphone and a speaker. The hands-free telephone 18 allows a driver to communicate with the external element without requiring dialing operation by the driver. That is, for example, when the driver operates a switch provided in a steering wheel or performs voice operation, the hands-free telephone 18 automatically dials a predetermined telephone number that is stored in the external memory 17 in advance. Thus, the driver can communicate with the external element without dialing. The hands-free telephone 18 can communicate with the external element since the telephone speech channel is established via the microcomputer 11 due to the wireless communication between the communication device 16 and the base station 40.

Further, the microcomputer 11 is connected to an emergency call switch 19 and an indicator lamp 19a. The emergency call switch 19 is pushed by the driver or a fellow passenger when an abnormality occurs in the vehicle or the occupant becomes sick suddenly. When the emergency call switch 19 is pushed by the user, the emergency call switch 19 outputs an emergency signal to the microcomputer 11.

The indicator lamp 19a is integrally incorporated in the emergency call switch 19. The indicator lamp 19a notifies the user whether the user can receive the rescue service, according to the indication from the microcomputer 11. That is, if the user has made a contract with the center 20 for receiving the rescue service, and the rescue service is available using the wireless communication, the indicator lamp 19a is on, which notifies the user that the rescue service is available. If the user has not made the contract with the center 20 for receiving the rescue service, or if the service contract period has expired and the rescue service is not available, the indicator lamp 19a is off, which notifies the user that the rescue service is not available.

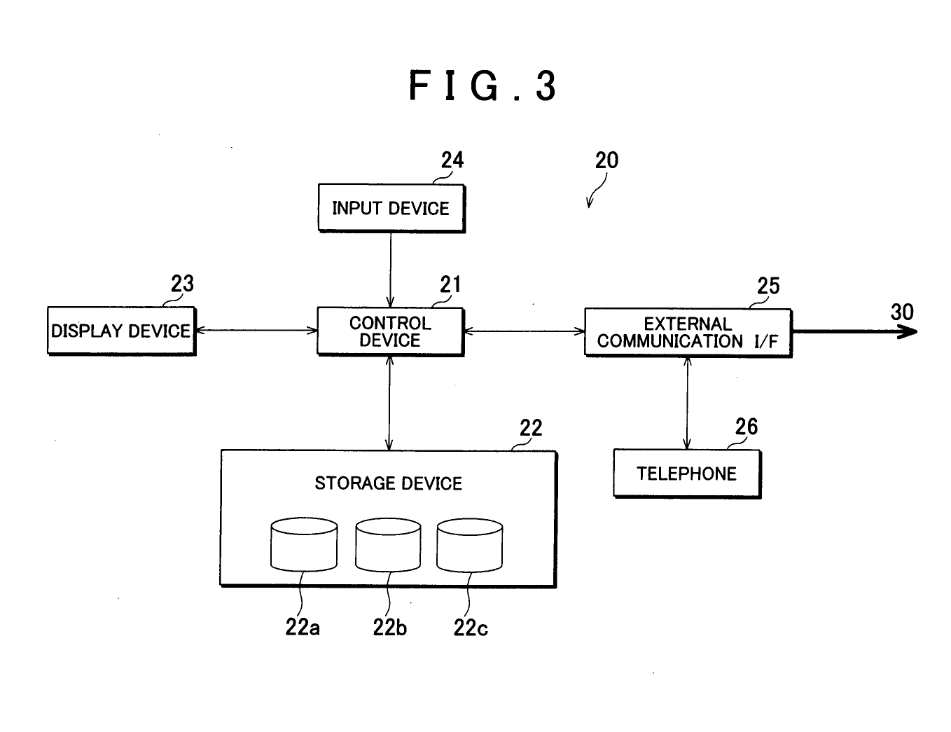

As shown in FIG. 3, the center 20 includes a control device 21, a storage device 22, a display device 23, an input device 24, and an external communication interface 25 (hereinafter, referred to as “external communication I/F 25), which are connected to each other so that they can communicate with each other. The control device 21 mainly includes a CPU, ROM, RAM, and a timer. The control device 21 controls operation of the storage device 22, the display device 23, the input device 24, and the external communication I/F 25 by performing various programs including the programs on the center side shown in FIG. 4 and FIG. 5. Also, the control device 21 sends, to the in-vehicle information terminal device 10, service contract expiration date information indicating an expiration date of the rescue service contract.

The storage device 22 includes storage media such as a hard disk, CD-ROM, and DVD-ROM, and a drive device for the storage media. The storage device 22 stores the various programs including the aforementioned programs performed by the control device 21 and various data. In the hard disk in the storage device 22, each of user information database 22a, service contract information database 22b, and road database 22c is constructed such that each of the databases can be searched.

The user information database 22a stores user information used for identifying the user of the vehicle in such a manner that the user information can be retrieved. The user information includes not only information used for identifying the owner of the vehicle, but also information used for identifying family members and acquaintances of the owner. Also, the user information stored in the user information database 22a is stored in association with the vehicle ID information used for identifying the vehicle, which is given to the vehicle in advance.

The service contract information database 22b stores service contract information indicating the contract concerning the rescue service which has been made between the user and the center 20, in such a manner that the service contract information can be retrieved. The service contract information includes information concerning the content of the rescue service which the user wants to receive, the service contract expiration date information indicating the expiration date of the service contract which is designated by the user, communication contract information used for performing communication, and the like. In principle, the expiration date of the service contract and the expiration date of the communication contract are the same date. The road database 22c is used for determining a present position of the vehicle when the center requests the emergency vehicle or the like to go into action based on the emergency information sent from the vehicle. Therefore, the road database 22c stores road map information indicating a detailed nationwide road map in such a manner that the road map information can be retrieved.

The display device 23 includes a liquid crystal display (not shown), and the like. The display device 23 displays, to an operator at the center 20, various information including the present position of the vehicle, the content of the service contract made by the user, and the like. The input device 24 includes a keyboard, a mouse, and the like (not shown). The content of the service contract made by the user, and the like are input to the input device 24 according to operation of the operator. The external communication I/F 25 is connected to the network 30 such that the communication channel and the telephone speech channel are established between the center 20, and the base station 40, the fire station 50, and the police station 60.

Accordingly, the external communication I/F 25 is connected to a telephone 26 used by the operator at the center 20. The operator at the center 20 uses the telephone 26 to speak with the driver or the fellow passenger via the hands-free telephone 18, or to give necessary information to the fire station 50 or the police station 60. The external communication I/F 25 can obtain various information from the vehicle via the base station 40, and supply the information to the control device 21. Also, the external communication I/F 25 can obtain various information from the control device 21 and send the information to the vehicle.

Next, hereinafter, operation of the service contract state determination system thus configured will be described. First, the user of the vehicle makes the rescue service contract with the center 20 for receiving the rescue service, for example, when the user purchases the vehicle. The rescue service contract will be described with reference to “the rescue service contract program” shown in FIG. 4.

When the ignition switch 13 is turned on, “the rescue service contract program” starts to be performed in step S10. In step S11, the microcomputer 11 establishes the telephone speech channel between the hands-free telephone 18 and the telephone 26 at the center 20. More specifically, the user touches a button indicating the start of a service contract procedure, which is displayed in a screen (not shown) of the in-vehicle information terminal device 10. The microcomputer 11 instructs the hands-free telephone 18 to dial the telephone number of the telephone 26 at the center 20 based on the touch operation performed by the user. The hands-free telephone 18 obtains the telephone number of the telephone 26 stored in the external memory 17 in advance, and dials the obtained telephone number, according to the instruction from the microcomputer 11.

Thus, when the hands-free telephone 18 dials the telephone number of the telephone 26, a signal that is output due to the dialing is sent to the base station 40 via the microcomputer 11 and the communication device 16 through wireless communication. The signal received by the base station 40 is sent to the telephone 26 at the center 20 via the network 30 by performing a predetermined connection process.

Thus, the telephone 26 at the center 20 is called. When the operator at the center 20 takes up the telephone 26, the telephone speech channel is established between the hands-free telephone 18 and the telephone 26. When the telephone speech channel is established between the hands-free telephone 18 and the telephone 26 in this manner, the user can speak with the operator at the center 20 on the telephone. Therefore, the user speaks with the operator in order to make the contract for receiving the rescue service with the center. In other words, the user tells the operator items necessary for making the contract, such as the name of the user, the content of the contract, the contract period (the starting date of the contract, and the expiration date of the contract), and the telephone number assigned to the in-vehicle information terminal device 10. The operator inputs the items necessary for making the contract, which are told by the user, using the input device 24. The items are temporarily stored in the RAM (not shown) in the control device 21 in the center 20.

After the telephone speech channel is established in step S11, the microcomputer 11 sends present position information indicating the present position of the vehicle to the center 20 in step S12. The microcomputer 11 sends this present position information in order to determine whether the present position information necessary for receiving the rescue service is appropriately sent to the center 20. More specifically, the microcomputer 11 instructs the GPS receiver 12 to output the present position of the vehicle as the coordinate data. The GPS receiver 12 outputs the coordinate data of the detected present position of the vehicle to the microcomputer 11. The microcomputer 11 obtains the output coordinate data, that is, the present position information on the vehicle, and temporarily stores the obtained present position information in the RAM (not shown). Then, the routine proceeds to step S13.

In step S13, the microcomputer 11 sends, to the center 20, the present position information that is temporarily stored in the RAM in the aforementioned step S12, and the vehicle ID information that is stored in the external memory 17. More specifically, the microcomputer 11 obtains the vehicle ID information that is stored in the external memory 17. Then, the microcomputer 11 supplies the communication device 16 with the obtained vehicle ID information and the present position information that is temporarily stored in the RAM, and instructs the communication device 16 to send the vehicle ID information and the present position information to the center 20. According to the instruction from the microcomputer 11, the communication device 16 sends the supplied present position information and the vehicle ID information to the center 20 via the base station 40.

In step C10, in the center 20, the control device 21 receives the present position information on the vehicle and the vehicle ID information that is sent through the sending process in the aforementioned step S13, and temporarily stores each information in the RAM. After each information is stored, the routine proceeds to step C11.

In step C11, the control device 21 displays the present position of the vehicle in the display device 23 based on the present position information on the vehicle which is received in the aforementioned step C10. More specifically, the control device 21 searches the road database 22c in the storage device 22 based on the present position information that is temporarily stored in the RAM. Then, the control device 22 obtains road data concerning road around the position indicated by the present position information.

Next, the control device 21 supplies the obtained road data and the present position information to the display device 23, and instructs the display device 23 to display the road data and the present position of the vehicle on the liquid crystal display. According to the instruction from the control device 21, the display device 23 displays the supplied road data and the present position of the vehicle on the liquid crystal display. Thus, since the present position of the vehicle is displayed on the liquid crystal display of the display device 23, the operator at the center 20 can determine that the present position of the vehicle which is necessary for providing the rescue service is normally sent from the vehicle. After the control device 21 instructs the display device 23 to display the present position of the vehicle, the routine proceeds to step C12.

In step C12, the control device 21 registers user ID information and the service contract information in association with the vehicle ID information that is temporarily stored in the RAM in the aforementioned step C10. The registration process will be described more specifically. In the aforementioned step S11, the user tells the operator the items necessary for making the service contract using the telephone speech channel established by the in-vehicle information terminal device 10. The items are temporarily stored in the RAM of the control device 21 by the input operation performed by the operator. Therefore, in step C12, the control device 21 obtains the information indicating the items necessary for making the service contract, which are temporarily stored in the RAM.

Based on the each obtained information, the control device 21 decides the user ID information indicating the user ID used for identifying the user, and decides the service contract information indicating the content of the rescue service (for example, a condition for requesting the rescue vehicle to go into action), the service contract period, the telephone number of the in-vehicle information terminal device 10, and the like. Also, the control device 21 obtains the vehicle ID information that is temporarily stored in the RAM in the aforementioned step C10.

The control device 21 supplies the storage device 22 with the decided user ID information and the obtained vehicle ID information. In addition, the control device 21 instructs the storage device 22 to register the user ID information and the vehicle ID information in association with each other in the user information database 22a. According to the instruction from the control device 21, in the storage device 22, the supplied user ID information and the vehicle ID information are registered in association with each other in the user information database 22a in such a manner that each information can be retrieved.

Also, the control device 21 supplies the storage device 22 with the decided user ID information and the service contract information, and the obtained vehicle ID information. In addition, the control device 21 instructs the storage device 22 to register the user ID information, the service contract information, and the vehicle ID information in association with each other in the service contract information database 22b. According to the instruction from the control device 21, in the storage device 22, the supplied user ID information, the service contract information, and the vehicle ID information are registered in association with each other in the service contract information database 22b in such a manner that each information can be retrieved. After each information is registered in the user information database 22a and the service contract information database 22b, the routine proceeds to step C13 in the control device 21.

In step C13, the control device 21 obtains the service contract expiration date information indicating the expiration date of the service contract in the service contract information that is registered in the aforementioned step C12, and sends the service contract expiration date information to the in-vehicle information terminal device 10. That is, the control device 21 searches the service contract information database 22b using the vehicle ID information that is temporarily stored in the aforementioned step C10, and obtains the service contract information that is registered in association with the vehicle ID information matching the vehicle ID information.

The control device 21 retrieves the service contract expiration date information in the obtained service contract information, and supplies the service contract expiration date information to the external communication I/F 25. At this time, the control device 21 instructs the external communication I/F 25 to send the supplied service contract expiration date information to the in-vehicle information terminal device 10 via the base station 40. The external communication I/F 25 obtains the service contract expiration date information, and sends the service contract expiration date information to the in-vehicle information terminal device 10 via the base station 40.

In step S14, the microcomputer 11 provided in the in-vehicle information terminal device 10 receives, via the communication device 16, the service contract expiration date information that is sent through the sending process in the aforementioned step C13. The microcomputer 11 temporarily stores the received service contract expiration date information in the RAM, and then the routine proceeds to step S15.

In step S15, the microcomputer 11 causes the external memory 17 to store, in a predetermined storage location, the service contract expiration date information that is temporarily stored in the RAM in the aforementioned step S14, and sets the expiration date of the rescue service contract. After the expiration date of the rescue service contract is set, the routine proceeds to step S16. In step S16, the microcomputer 11 sets a contract flag FRG indicating the contract state of the rescue service to “1”, which indicates that the rescue service contract has been made. Then, in step S17, “the rescue service contract program” is finished.

In the case where the contract is extended (the contract is made again) when the contract period expires, the user tells the operator at the center 20 that the user wants to extend the contract, in the same manner as in “the rescue service contract program”. Thus, after the contract is made again, the control device 21 renews the service contract information.

In the case where the user cancels, before the expiration date of the contract, the rescue service contract that has been made in the aforementioned manner, the user tells the operator at the center 20 that the user wants to cancel the rescue service contract using the established telephone speech channel, in the same manner as in “the rescue service contract program”. Then, the center 20 cancels the registration of the user ID information and the service contract information in the user information database 22a and the service contract information database 22b, using the vehicle ID information sent by the in-vehicle information terminal device 10.

After the registration of the user ID information and the service contract information is canceled, the center 20 sends, to the in-vehicle information terminal device 10, cancellation information indicating that the rescue service has been canceled. When receiving the cancellation information, the in-vehicle information terminal device 10 sets the contract flag FRG to “0”, which indicates that the rescue service contract has not been made.

Also, in the case where the rescue service contract is not extended after the service contract period thereof expires, the center 20 sends, to the in-vehicle information terminal device 10, the cancellation information indicating that the rescue service has been canceled. When receiving the cancellation information, the in-vehicle information terminal device 10 sets the contract flag FRG to “0”, which indicates that the rescue service contract has not been made.

As described above, in the case where the rescue service contract has been made by performing “the rescue service contract program”, the user can receive the rescue service when an abnormality occurs in the vehicle (when the airbag device 14 is operated), or when the occupant becomes sick suddenly. That is, when the airbag device 14 is operated, or when the occupant pushes the emergency call switch 19, the microcomputer 11 obtains the emergency signal, and sends, to the center 20, the vehicle ID information of the vehicle and the present position of the vehicle.

Also, the microcomputer 11 establishes the telephone speech channel between the in-vehicle information terminal device 10 and the center 20, and the occupant can speak with the operator at the center 20 using the hands-free telephone 18. The operator requests the fire station 50 to dispatch an ambulance, or requests the police office 60 to dispatch a police car, as a necessary action. At this time, since the operator receives the present position information on the vehicle, the operator can appropriately tell the fire station 50 or the police station 60 the destination to which the ambulance or the police car is dispatched. Thus, the user can receive the rescue service quickly and reliably.

Next, referring to FIG. 5, detailed description will be made on operation of “the service contract state determination program” for determining whether the rescue service contract is effective, that is, whether the contract period of the present rescue service contract has expired.

Every time the engine of the vehicle is started, that is, every time the user turns the ignition switch 13 on, “the service contract state determination program” is started in step S50. In step S51, the microcomputer 11 of the in-vehicle information terminal device 10 determines whether the contract flag FRG is set to “1”. That is, if the contract flag FRG is set to “1” which indicates that the rescue service contract has been made, the microcomputer 11 makes an affirmative determination, and the routine proceeds to step S52.

If the contract flag FRG is set to “0” which indicates that the rescue service contract has not been made, the microcomputer 11 makes a negative determination, and the routine proceeds to step S61. Then, in step S61, the microcomputer 11 turns the indicator lamp 19a off, and notifies the user that the service contract has not been made. Thus, after the indicator lamp 19a is turned off, the routine proceeds to step S62 in the microcomputer 11, and “the service contract state determination program” is finished.

In step S52, the microcomputer 11 determines the present date. More specifically, the microcomputer 11 calculates and determines the present date using the timer (not shown) and the like. After the present date is determined, the routine proceeds to step S53. In step S53, the microcomputer 11 determines whether the contract period of the rescue service contract has expired using the present date determined in the aforementioned step S52. More specifically, the microcomputer 11 compares the expiration date of the rescue service contract which is set by performing the aforementioned “rescue service contract program”, and the present date which is determined in the aforementioned step S52.

As a result of this comparison, if the contract period of the rescue service contract has not expired, the microcomputer 11 makes an affirmative determination, and the routine proceeds to step S60. In step S60, the microcomputer 11 turns the indicator lamp 19a on, and notifies the user that the rescue service contract has been made, and the user can receive the rescue service.

If it is determined that the contract period of the rescue service contract has expired in step S53, the microcomputer 11 makes a negative determination, and the routine proceeds to step S54. In step S54, the microcomputer 11 attempts to establish the telephone speech channel between the in-vehicle information terminal device 10 and the center 20 using the communication device 16. That is, the microcomputer 11 obtains the telephone number of the center 20 that is stored in the external memory 17 in advance, and supplies the telephone number to the communication device 16. In addition, the microcomputer 11 instructs the communication device 16 to establish the communication channel between the in-vehicle information terminal device 10 and the center 20. According to the instruction from the microcomputer 1, the communication device 16 attempts to establish the communication channel between the in-vehicle information terminal device 10 and the center 20.

After the process of attempting to establish the communication channel is performed in the aforementioned step S54, the microcomputer 11 determines whether the communication channel has been established in step S55. That is, if the communication channel is established, the microcomputer 11 makes an affirmative determination, and the routine proceeds to step S56. If the communication channel has not been established, the microcomputer 11 makes a negative determination. Then, the routine proceeds to step S60, and the microcomputer 11 turns the indicator lamp 19a on. Thus, the user is notified that the user can receive the rescue service though the contract period has expired, because the in-vehicle information terminal device 10 cannot determine whether the rescue service contract has been extended by the user in the case where the communication channel has not been established.

That is, as described later, when the in-vehicle information terminal device 10 receives the latest service contract expiration date information from the center 20, the in-vehicle information terminal device 10 determines whether the rescue service contract has been made again (i.e., the rescue service contract has been extended) by the user. Therefore, if the microcomputer 11 were to determine that the contract period of the rescue service contract has expired and the user cannot receive the rescue service in the case where the communication channel has not been established, there would be a possibility that the user cannot receive the rescue service even in the case where the rescue service contract has been actually extended.

Accordingly, in the case where the communication channel cannot be established, the microcomputer 11 determines that the rescue service contract has been extended, and continues to provide the rescue service. In this case, the microcomputer 11 continues to provide the rescue service until the ignition switch 19 that is on at present is turned off. Also, in the case where the communication channel cannot be established, the microcomputer 11 may repeatedly attempt to establish the communication channel only during a predetermined time period (for example, five minutes) after the ignition switch 13 is turned on.

In step S56, the microcomputer 11 sends contract renewal determination information and the vehicle ID information to the center 20. More specifically, since the service contract information stored in the center 20 has been renewed, the microcomputer 11 makes the contract renewal determination information used for determining whether the service contract expiration date information has been renewed. Then, the microcomputer 11 supplies the communication device 16 with the vehicle ID information that is stored in the external memory 17 and the contract renewal determination information. The communication device 16 sends the supplied contract renewal determination information and the vehicle ID information to the center 20.

In the center 20, in step C50, the control device 21 receives the contract renewal determination information and the vehicle ID information that is sent through the sending process in the aforementioned step S56. In addition, the center 20 temporarily stores each received information in the RAM, and the routine proceeds to step C51. In step C51, the control device 21 searches the service contract information database 22b in the storage device 22 using the vehicle ID information, based on the contract renewal determination information that is temporarily stored in the RAM in the aforementioned step C50. Then, the control device 21 obtains the service contract information that is stored in association with the vehicle ID information matching the aforementioned vehicle ID information that is temporarily stored. Thus, after the service contract information is obtained, the control device 21 temporarily stores the obtained service contract information in the RAM, and the routine proceeds to step C52.

In step C52, the control device 21 obtains the service contract expiration date information in the service contract information that is temporarily stored in the RAM in the aforementioned step C51. Then, the control device 21 supplies the obtained service contract expiration date information to the external communication I/F 25. The external communication I/F 25 sends the supplied service contract expiration date information to the in-vehicle information terminal device 10 via the base station 40.

In the in-vehicle information terminal device 10, in step S57, the microcomputer 11 receives the service contract expiration date information that is sent through the sending process in the aforementioned step C52. Then, the microcomputer 11 temporarily stores the received service contract expiration date information in the RAM, and the routine proceeds to step S58. In step S58, the microcomputer 11 redetermines whether the contract period of the rescue service contract has expired, based on the service contract expiration date information that is temporarily stored in the RAM in the aforementioned step S57. That is, the microcomputer 11 compares the present date that is determined in the aforementioned step S52 and the service contract expiration date information that is temporarily stored in the RAM in the aforementioned step S57.

If it is determined that the service contract period has not expired, that is, the rescue service contract has been made again and has been extended at present based on the comparison, the microcomputer 11 makes an affirmative determination, and the routine proceeds to step S59. In step S59, the microcomputer 11 renews the expiration date of the rescue service contract that has been stored in the external memory 17 in advance, based on the service contract expiration date information that is temporarily stored in the RAM in the aforementioned step S57. Then, the microcomputer 11 stores the renewed expiration date of the rescue service contract. Thus, every time the ignition switch 13 is turned on next time and thereafter, the microcomputer 11 refers to the renewed expiration date to determine whether the service contract period has expired in the aforementioned step S53.

After the process of renewing the expiration date is performed in the aforementioned step S59, the routine proceeds to step S60. In step S60, the microcomputer 11 turns the indicator lamp 19a on, and notifies the user that the service contract has been made, and the user can receive the rescue service. Then, in step S62, “the service contract state determination program” is finished.

Meanwhile, if the contract has not been extended and the service contract period has expired at present, the microcomputer 11 makes a negative determination in step S58, and the routine proceeds to step S61. In step S61, the microcomputer 11 turns the indicator lamp 19a off, and notifies the user that the service contract has not been made. Thus, after the indicator lamp 19a is turned off, the routine proceeds to step S62 in the microcomputer 11, and “the service contract state determination program” is finished.

As is apparent from the description that has been made so far, according to the embodiment of the invention, the in-vehicle information terminal device 10 and the center 20 can maintain the same service contract expiration date information (communication contract information). Also, even in the case where the service contract expiration date information (communication contract information) has been renewed, since the service contract expiration date information (communication contract information) in the in-vehicle information terminal device 10 and that in the center 20 are synchronized, the in-vehicle information terminal device 10 and the center 20 can maintain the same service contract expiration date information (communication contract information).

Thus, the center 20 can provide the service to the in-vehicle information terminal device 10 based on the correct service contract. Also, since the in-vehicle information terminal device 10 sends the contract renewal determination information, and the center 20 receives the contract renewal determination information, the service contract expiration date information (communication contract information) in the in-vehicle information terminal device 10 and that in the center 20 are synchronized. Accordingly, for example, it is possible to minimize the possibility that that the communication channel cannot be established due to a deteriorated state of communication. Therefore, the service contract expiration date information (communication contract information) in the in-vehicle information terminal device 10 and that in the center 20 can be synchronized with more reliability. Also, since the in-vehicle information terminal device 10 sends the contract renewal determination information based on the service contract expiration date information, the number of times of communication can be reduced, which is advantageous.

Also, since the in-vehicle information terminal device 10 and the center 20 communicate with each other based on the renewed service contract information, the center 20 can reduce a period during which the rescue service is provided free of charge though the expiration date of the rescue service contract has expired. Also, since the indicator lamp 19a is turned on and off based on the service contract information, the user who receives the rescue service can easily determine whether the rescue service is available at present. Therefore, the user can prevent the rescue service contract from being canceled though the user wants to receive the rescue service. In addition, even the user who is not the owner of the vehicle can determine the state of the contract extremely easily. Further, since the contract renewal determination information is sent within a predetermined time after the engine of the vehicle is started, that is, after the ignition switch is turned on, the number of times of communication can be reduced, and accordingly the load of the communication channel can be reduced.

In the aforementioned embodiment, the in-vehicle information terminal device 10 functions as the second device, and the center 20 functions as the first device. The user registers the service contract information in the center 20, and the center 20 sends the service contract information to the in-vehicle information terminal device 10. Instead, the in-vehicle information terminal device 10 may function as the first device, and the center 20 may function as the second device. That is, the user may register the service contract information (communication contract information) in the in-vehicle information terminal device 10, and the in-vehicle information terminal device 10 may send the registered service contract information to the center. In this case, the center 20 sends the contract renewal determination information to the in-vehicle information terminal device 10 with a predetermined frequency, whereby the center 20 can determine whether the service contract information (communication contract information) has been renewed. In this case as well, since the in-vehicle information terminal device 10 and the center 20 can maintain the synchronized service contract information, it is possible to obtain effects similar to those obtained in the aforementioned embodiment.

Further, in the aforementioned embodiment, the information communication system according to the invention is applied to the wireless communication between the in-vehicle information terminal device 10 and the center 20. However, it is to be understood that various modifications can be made without departing from the true spirit of the invention. For example, the invention can be applied to communication between devices that are connected with each other by a cable.

1. An information communication method in which a first device and a second device communicates with each other based on a communication contract, comprising the steps of:
in the first device:
storing information concerning the communication contract which has been made in advance in such a manner that the information can be renewed; and
sending the stored information concerning the communication contract to the second device;
in the second device:
receiving and storing the information concerning the communication contract sent by the first device; and
sending, to the first device, contract renewal determination information used for determining whether the communication contract has been renewed; and
in the first device:
sending information concerning the renewed communication contract to the second device if the communication contract has been renewed.

2. The information communication method according to claim 1, wherein the second device receives and stores contract expiration date information indicating an expiration date of the communication contract, which is sent by the first device; the second device determines if the expiration date of the communication contract has been passed; the second device sends, to the first device, contract renewal determination information used for determining whether the communication contract has been renewed if the expiration date of the communication contract has been passed; the first device receives the contract renewal determination information sent by the second device; and the first device sends, to the second device, the contract expiration date information in the information concerning the renewed communication contract if the communication contract has been renewed.

3. The information communication method according to claim 1, wherein one of the first device and the second device is installed in a center which provides various services to a user, and the other of the first device and the second device is installed in a vehicle used by the user.

4. The information communication method according to claim 1, wherein the contract renewal determination information is sent within a predetermined time after operation of the second device is started.

5. The information communication method according to claim 4, wherein the contract renewal determination information is sent within a predetermined time after an engine of the vehicle is started when the second device is installed in the vehicle.

6. The information communication method according to claim 3, wherein the information concerning the communication contract is included in information concerning a contract for provision of various services.

7. An information communication system in which a first device and a second device communicate with each other on a communication contract, wherein:
the first device includes:
a first storage device which stores information concerning the communication contract which has been made in advance in such a manner that the information can be renewed;
an information renewal device which renews the information concerning the communication contract stored by the storage device;
a first sending device which sends, to the second device, the information concerning the communication contract stored by the storage device; and
a first receiving device which receives, from the second device, contract renewal determination information used for determining whether the communication contract has been renewed; and
the second device includes:
a second receiving device which receives the information concerning the communication contract sent by the first device;
a second storage device which stores the information concerning the communication contract received by the second receiving device; and
a second sending device which sends the contract renewal determination information to the first device.

8. The information communication system according to claim 7, wherein:
the first device further includes:
an information retrieving device which retrieves contract expiration date information indicating an expiration date of the communication contract in the information concerning the communication contract stored by the first storage device; and
a contract information renewal determination device which determines whether the information concerning the communication contract has been renewed based on the contract renewal determination information received by the first receiving device; and
the second device further includes:
a contract expiration date determination device which determines whether the expiration date of the communication contract has been passed based on the contract
expiration date information stored by the second storage device, wherein the first sending device sends, to the second device, the contract expiration date information retrieved by the information retrieving device; and
the second sending device sends the contract renewal determination information to the first device when the contract expiration date determination device determines that the expiration date of the communication contract has been passed.

9. The information communication system according to claim 7, wherein one of the first device and the second device is installed in a center which provides various services to a user, and the other of the first device and the second device is installed in a vehicle used by the user.

10. The information communication system according to claim 7, wherein the contract renewal determination information is sent within a predetermined time after operation of the second device is started.

11. The information communication system according to claim 10, wherein the contract renewal determination information is sent within a predetermined time after an engine of the vehicle is started when the second device is installed in the vehicle.

12. The information communication system according to claim 9, wherein the information concerning the communication contract is included in information concerning a contract for provision of the various services.

13. An information communication apparatus which communicates with an external element based on a communication contract, comprising:
a storage device which stores information concerning the communication contract that has been made in advance in such a manner that the information can be renewed;
an information renewal device which renews the information concerning the communication contract stored by the storage device;
a sending device which sends, to the external element, the information concerning the communication contract stored by the storage device; and
a receiving device which receives, from the external element, contract renewal determination information used for determining whether the communication contract has been renewed.

14. The information communication apparatus according to claim 13, further comprising:
an information retrieving device which retrieves contract expiration date information indicating an expiration date of the communication contract in the information concerning the communication contract stored by the storage device; and
a contract information renewal determination device which determines whether the information concerning the communication contract has been renewed based on the contract renewal determination information received by the receiving device.

15. The information communication apparatus according to claim 13, wherein the information communication apparatus is installed in a center which provides various services to the external element or a vehicle.

16. The information communication apparatus according to claim 13, wherein the contract renewal determination information is sent within a predetermined time after operation of the information communication apparatus is started.

17. The information communication apparatus according to claim 16, wherein the contract renewal determination information is sent within a predetermined time after an engine of the vehicle is started when the information communication apparatus is installed in the vehicle.

18. The information communication apparatus according to claim 15, wherein the information concerning the communication contract is included in information concerning a contract for provision of the various services.

19. An information communication apparatus which communicates with an external element based on a communication contract, comprising:
a receiving device which receives, from the external element, information concerning the communication contract;
a storage device which stores information concerning the communication contract received by the receiving device; and
a sending device which sends, to the external element, contract renewal determination information used for determining whether the communication contract has been renewed.

20. The information communication apparatus according to claim 19, further comprising a contract expiration date determination device which determines whether an expiration date of the communication contract has been passed based on contract expiration date information indicating the expiration date of the communication contract, which is stored by the storage device, wherein the sending device sends, to the external element, the contract renewal determination information used for determining whether the communication contract has been renewed when it is determined, by the contract expiration date determination device, that the expiration date of the communication contract has been passed.

21. The information communication apparatus according to claim 19, wherein the information communication apparatus is installed in a center which provides various services to the external element or a vehicle.

22. The information communication apparatus according to claim 19, wherein the contract renewal determination information is sent within a predetermined time after operation of the information communication apparatus is started.

23. The information communication apparatus according to claim 22, wherein the contract renewal determination information is sent within a predetermined time after an engine of the vehicle is started when the information communication apparatus is installed in the vehicle.

24. The information communication apparatus according to claim 19, wherein the information concerning the communication contract is included in information concerning a contract for provision of the various services.
